(19) United States
(12) Patent Application Publication
(10) Pub. No.: US 2005/0070307 A1
(43) Pub. Date: Mar. 31, 2005

(54) Method for multi-network data transmission

(76) Inventor: Philippe Charbonnier, Le Mesnil Le Roi (FR)

Correspondence Address: BRIGGS AND MORGAN, P.A., 2200 IDS CENTER, MINNEAPOLIS, MN, 55402, US

(21) Appl. No.: 10/490,536

(22) PCT Filed: Sep. 11, 2002
(86) PCT No.: PCT/FR02/03084

(30) Foreign Application Priority Data
Sep. 24, 2001 (FR) 01 12345

(51) Int. Cl. H04Q 7/20

(52) U.S. Cl. 455/456.3; 455/456.1

(57) ABSTRACT

The invention concerns a data transmission method for connecting at least a mobile transceiver (MOB) to a communication network (NW) selected among a plurality of such networks (NWi), i=1 to 5. The inventive method is characterized in that it comprises a step of locating and identifying a transceiver (MOB) adapted by its geographical location to communicate with at least two different communication networks (NW1 and NW2), and a step of transmitting to said transceiver (MOB) characteristics particular to the networks which are operational in the site where the transceiver (MOB) has been located. The invention enables to select only the transceivers which are located in zone where several communication networks are operational, so as to send and information to them selectively, thereby not disturbing the other transceivers present in said region.

This invention concerns a method for transmitting data intended to be placed in communication with a communication network selected from a multiplicity of such networks, with at least one mobile transmitter/receiver, said communication networks each having specific characteristics that differ from one network to another.

These types of methods are, for example, commonly used to allow bi-modal radiotelephones to communicate with, as desired, a first GSM network or a second DCS1800 network. In this example, the technologies of the first and second networks are both cellular and sufficiently similar so that switching from one network to another requires only minor adjustments of the transmitter/receiver, such as reprogramming the oscillating frequency ranges in transmission and receiving tuners.

The transmitter/receiver can, however, be placed in multi-network environments where the networks present have characteristics that differ greatly from one network to another, as is the case for UMTS cellular networks, IRIDIUM or GLOBALSTAR satellite networks or local DECT or WLAN networks.

In certain cases, it may be advantageous for a mobile transmitter/receiver located in a multi-network environment to switch from one network to another, for example in case of the saturation of the network with which it is connected, or if another network allows it to realize savings in terms of transmission costs or battery life.

The invention is tied to the following considerations:

The same cell of a first cellular network may, for example, include one or more areas in which one or more associated local networks distinct from the first network are operational. A mobile transmitter/receiver, configured to communicate with the first network, that enters this type of area and is endowed with suitable equipment could switch to the local network in order to use more advantageous capacities. The mobile transmitter/receiver concerned must, however, have been alerted in advance of the very existence of this type of possibility.

Information concerning the various areas included in the cell in which other communication networks are operational could be sent continuously to all the mobile transmitter/receivers dependent on said cell, but this measure would cause a significant increase in the communication volume within the cell, which could result in the saturation of said cell if the number of transmitters/receivers present in this cell is large.

This invention aims to eliminate this disadvantage to a large extent by proposing a data transmission method thanks to which a transmitter/receiver located in an area in which several communication networks are operational can be alerted of this without such a measure causing a significant increase in the communication volume for the network with which said transmitter/receiver is in communication.

Indeed, according to the invention, a data transmission method conform to the introductory paragraph includes:

a localization and identification step for a transmitter/receiver rendered capable by its geographic situation of communicating with at least two different communication networks, and
a transmission step, to a transmitter/receiver identified at the end of the location and identification step, of characteristics specific to operational communication networks in the location where said transmitter/receiver was located.

The method according to the invention makes it possible to select, from all the transmitters/receivers included in a same cell, to repeat the previous example, only the transmitters/receivers located in areas where other networks with which they are capable of communicating are operational. An informational message may then be sent selectively to the transmitters/receivers thus selected, which will not perturb the other transmitters/receivers present in the cell.

This advantage takes on an even larger dimension in an application of the method according to the invention to a set of cells of a communication network, a set within which are disseminated areas in which at least one other communication network is operational.

Thanks to the step involving the transmission of the characteristics specific to the communication networks operational in the location where it was located, the transmitter/receiver identified can be informed, in real time and as it moves, of the various possibilities offered to it inside the area in which it is located.

According to a variant of the invention, the method described above may include a step in which the configuration of the transmitter/receiver identified at the end of the location and identification step is analyzed and a step during which a possible compatibility of said configuration with the characteristics specific to communication networks operational in the location where said transmitter/receiver was located is evaluated.

The transmitter/receiver identified can then evaluate its ability to use the alternative network or networks thus described to it.

Indeed, if said communication networks are very different from one another, the transmitter/receiver may not be able to adapt itself immediately to the characteristics specific to an alternative network. For example, the deployment of a specific antenna may be necessary for compatibility with said network, or it may be necessary to load a hardware or software module or even for the user of the transmitter/receiver to indicate his acceptance of a new rate grid.

According to another variant of the invention, which might advantageously be used cumulatively with the variant previously described, a transmission method as described above may include a step during which the configuration of the transmitter/receiver identified at the end of the location and identification step is adapted, which adaptation step is intended to adapt said transmitter/receiver to at least one communication network operational in the location where said transmitter/receiver was located and distinct from a network with which the transmitter/receiver is already compatible.

This step can be implemented selectively, for example at the end of the evaluation step cited earlier, or routinely, without taking into account the prior configuration of the transmitter/receiver identified as being suitable for communicating with the new network.

The location and identification step can be implemented in different ways. The mobile transmitter/receiver, may, for example, be the subject of radiodetection by triangulation on the part of base stations of at least one terrestrial communication network or satellite network. This radiodetection will produce coordinates for the transmitter/receiver that will be compared with the pre-set contours of the areas in which the different communication networks are operational. If the coordinates of a mobile transmitter/receiver are included in a surface area defined by such a contour, said transmitter/receiver will be identified as suitable for communicating with the corresponding network.

In one of its applications, the invention also concerns a telecommunication system including at least one mobile transmitter/receiver intended to be placed in communication with a communication network selected from a multiplicity of such networks, said communication networks each having specific characteristics that differ from one network to another, a system characterized in that it includes:
means for locating and identifying a transmitter/receiver rendered capable by its geographic situation of communicating with at least two different communication networks, and
transmission means intended to transmit to a transmitter/receiver identified by the location and identification means characteristics specific to communication networks operational in the location where said transmitter/receiver was located.

In a variant of this application of the invention, the system described above may include means for analyzing the configuration of the transmitter/receiver identified at the end of the location and identification step, and a step for evaluating a possible compatibility of said configuration with the characteristics specific to communication networks operational in the location where said transmitter/receiver was located.

In another variant of the application of the invention described above, the telecommunication system will also be equipped with means for adapting the configuration of the transmitter/receiver identified at the end of the location and identification step, which adaptation means are intended to make transmitter/receiver compatible with at least one operational network in the location where said transmitter/receiver was located and distinct from a network with which the transmitter/receiver is already compatible.

The means of location and identification may also include base stations belonging to one or more terrestrial telecommunication networks or even satellites, for triangulating a position of the transmitter/receiver.

The invention also concerns a radiotelephone capable of performing the functions of a mobile transmitter/receiver used in a data transmission process or a telecommunication system as described earlier.

The features of the invention mentioned above, along with as others, will become clearer upon reading the following description of an example of embodiment, said description being given in relation to the appended drawings in which:

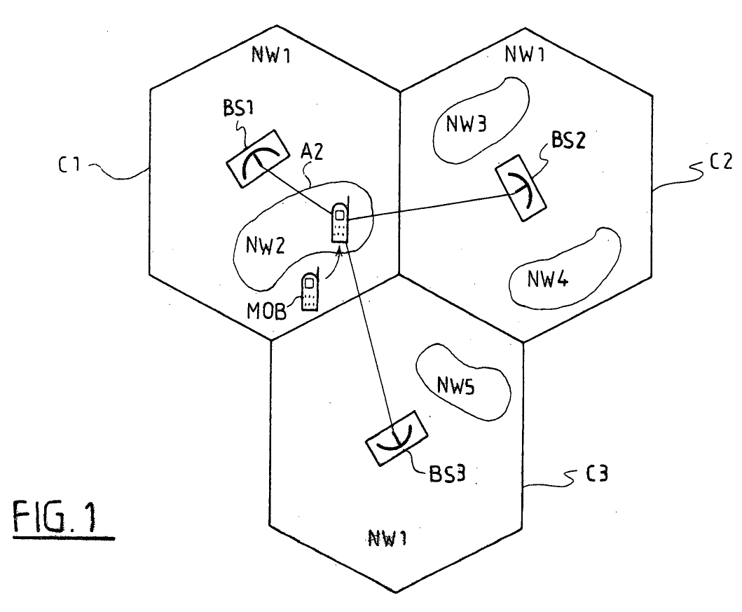

FIG. 1 is a diagram describing a telecommunication system according to a mode of implementation of the invention,

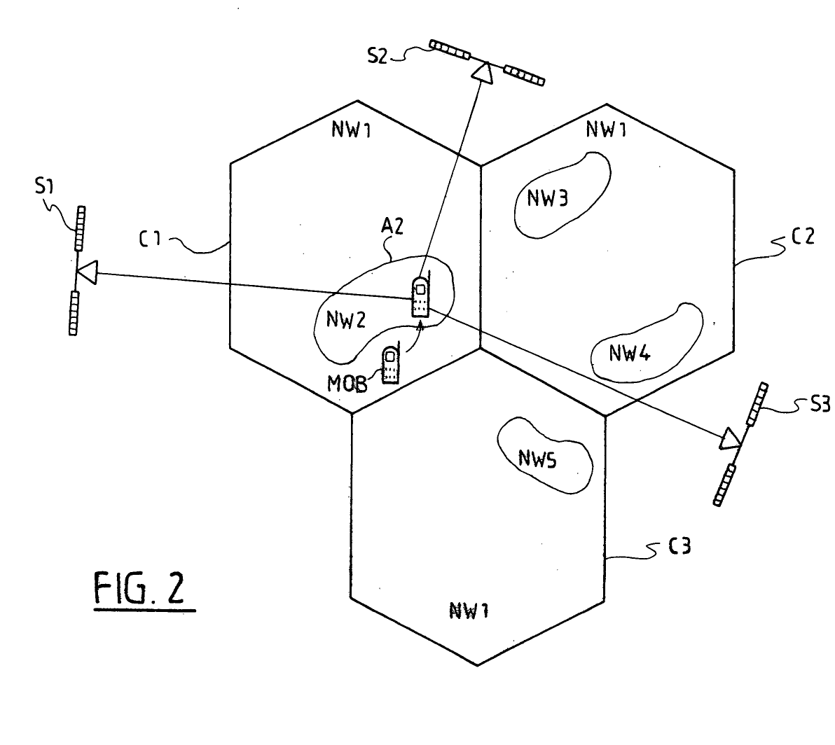

FIG. 2 is a diagram describing a variant of this telecommunication system,

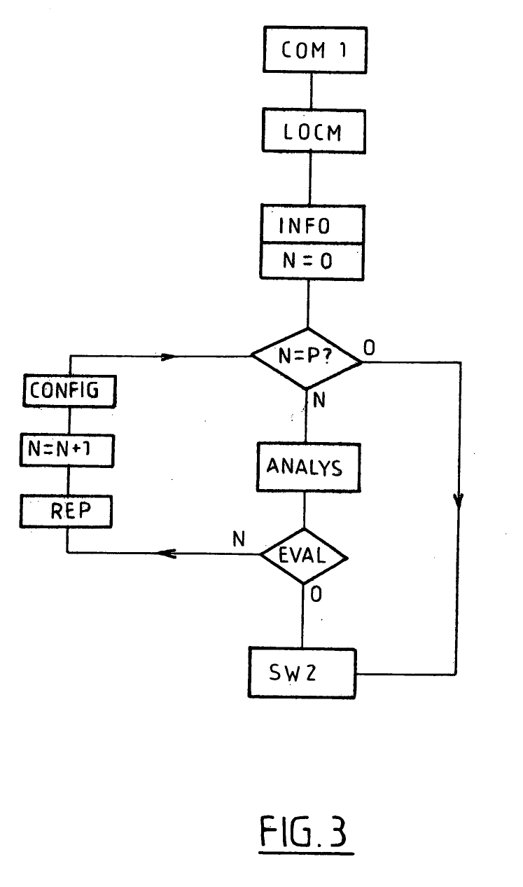

FIG. 3 is a flow chart describing a data transmission method used in such systems, and

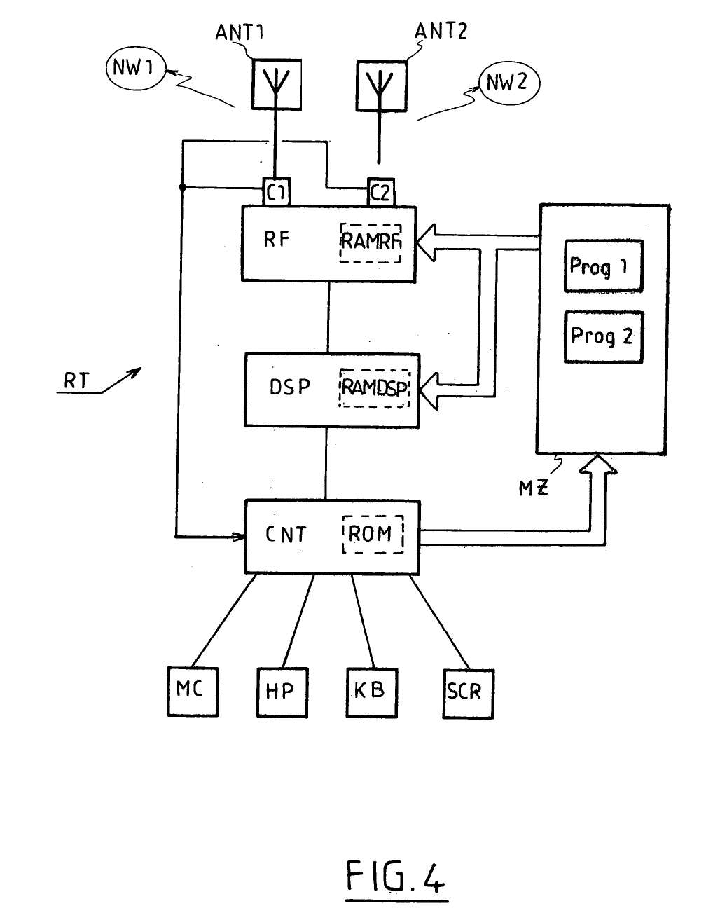

FIG. 4 is a functional diagram describing a possible mode of embodiment of a radiotelephone capable of being used in systems or methods represented previously.

FIG. 1 is a schematic representation of a telecommunication system in which the invention is implemented. In this example, the system includes a first cellular communication network NW1 that presents a first, a second and a third cell C1, C2 and C3, each equipped with a base station BS1, BS2 and BS3. A second communication network NW2 is operational in a perimeter associated with the first cell C1, a third and a fourth communication network NW3 and NW4 being operational in a perimeter associated with the second cell C2 and a fifth communication network NW5 being operational in a perimeter associated with the third cell C3. In the scenario described here, the second, third, fourth and fifth communication networks are local networks, for example DECT or WLAN networks. In other scenarios, any of these networks can be of a regional or even global dimension and cover one, more or all the territories covered by the cells of the first communication network NW1.

The telecommunication system described here also includes a mobile transmitter/receiver MOB, represented in the form of a radiotelephone, but which can also be a personal organizer or any portable item, provided that it is equipped with transmission and receiving functionalities. During one of its travel movements, represented in the figure by a directional arrow, said mobile MOB enters an area in which, in addition to the first communication network NW1, the second communication network NW2 is operational. This event is detected by a communication network management infrastructure. Indeed, the position of the mobile transmitter/receiver MOB is determined continuously by said infrastructure by means of triangulation performed by the base stations BS1, BS2 and BS3 of cells C1, C2 and C3. Each of the stations identifies a direction according to which a signal received from the mobile transmitter/receiver MOB has a maximum or minimum power. The infrastructure determines a point of convergence of the directions thus identified and deduces from it the coordinates of the mobile transmitter/receiver MOB. These coordinates are compared with the pre-set contours of the areas in which the different communication networks NW2, NW3, NW4 and NW5 are operational. If the coordinates of the mobile transmitter/receiver MOB are included in a surface area A2 defined by this type of contour, said transmitter/receiver MOB is identified as capable of communicating with the corresponding network NW2.

The infrastructure can then send an informational message selectively to the transmitter/receiver thus identified, which will not perturb other transmitters/receivers present in the cell C1.

In the example described previously, three base stations of the same cellular communication network are used to locate the mobile transmitter/receiver MOB via radiodetection. In other modes of implementation of the invention we can use only two base stations or even a single base station for this purpose if, in addition to a direction according to which a signal received from the mobile transmitter/receiver MOB has a maximum power, it is capable of identifying a temporal attenuation of said signal based on a distance separating the mobile transmitter/receiver MOB from the base station considered. It is also possible to use base stations belonging to different communication networks, as long as each of these stations communicates with a common management infrastructure capable of compiling the information coming from the different base stations.

We can also use measurements of the time necessary for a signal transmitted by the mobile transmitter/receiver MOB to reach different base stations or even the time necessary for signals transmitted synchronously by base stations to reach the mobile transmitter/receiver MOB, which will then communicate to the infrastructure the temporal deviation values it has measured. We can also envision combining power level and temporal measurements.

FIG. 2 is a schematic representation of a variant of a telecommunication system as described above in which the location and identification step is performed by means of satellites placed in orbit around the celestial body, Earth, for example, on whose surface said mobile transmitter/receiver MOB is intended to move. The elements of this telecommunication system that are common to the one represented in the preceding figure were assigned the same reference numbers and will not be described again here.

In this example, the position of the mobile transmitter/receiver MOB is determined by the infrastructure by means of triangulation performed by first, second and third satellites S1, S2 and S3. These satellites may belong to a communication network with which the mobile transmitter/receiver MOB is in communication, in which case said network locates the mobile transmitter/receiver MOB according to time and power measurement techniques mentioned earlier. The satellites S1, S2 and S3 can also belong to another network or a specific location constellation, for example of the GPS type, in which case the mobile transmitter/receiver MOB itself determines its position via temporal measurements and periodically reports its position to its management infrastructure. In all cases, the coordinates of the mobile transmitter/receiver MOB are intended to be compared with the pre-determined contours of the areas in which the different communication networks NW2, NW3, NW4 and NW5 are operational. The transmitter/receiver MOB will be identified as capable of communicating with the network NW2 if its coordinates are included in a surface area A2 defined by the corresponding contour. The infrastructure may then send an informational message selectively to the transmitter/receiver MOB thus identified, which will not perturb the other transmitters/receivers dependent on the first communication network NW1.

FIG. 3 is a flow chart that illustrates the process of a method conform to the particular mode of implementation of the invention

In an initial step COM1 of this method, a mobile transmitter/receiver is configured to communicate with a first communication network.

In a next step LOCM, called location and identification, said transmitter/receiver is identified as being equally capable, as a result of its geographic situation, of communicating with a second communication network.

In a next informational step INFO, the transmitter/receiver identified at the end of the location and identification step receives, from a management infrastructure of the first communication network, for example, a message describing characteristics specific to the second communication network that is operational in the location in which the transmitter/receiver was located.

In a next configuration analysis step ANALYS, the transmitter/receiver identified analyzes its own configuration.

In a next test step EVAL, said transmitter/receiver determines whether this configuration is compatible with the characteristics specific to the second communication network. If this is not the case, during a next step REP, the transmitter/receiver sends a report to the infrastructure to indicate to it that a switch to the second communication network is not possible. In a next reconfiguration step CONFIG, the transmitter/receiver considered then attempts to adapt its configuration to the specific characteristics of the second communication network, for example by modifying the configuration of its radio parts or even by ordering a user of said transmitter/receiver to deploy an antenna necessary for signal exchanges with said second network. This step is followed by another configuration analysis step ANALYS, then by another test step EVAL, at the end of which, if the configuration of the transmitter/receiver considered is successfully adapted to the specific characteristics of the second communication network, the transmitter/receiver signals the infrastructure that it is ready to end its link with the first communication network and to effectively enter into communication with the second communication network during a step SW2. In a variant of this step SW2, the transmitter/receiver may switch immediately to the second communication network without sending any prior warning to the infrastructure.

If, on the other hand, the new configuration of the transmitter/receiver is still not compatible with the specific characteristics of the second network, the transmitter/receiver still does not switch to the second communication network and sends a new report to the infrastructure to inform it of this state of affairs during a new step REP.

In certain situations, a switch to the second communication network can become necessary in order to avoid losing the communication, for example, because the first network is saturated. We can therefore arrange for the possibility of forcing the transmitter/receiver to switch to the second communication network at the end of a preset number P of configurations. To this end, the method according to the particular mode of implementation described here provides for the initialization at zero of a counter (N=0) during the information step INFO, said counter being incremented (N=N+1) before each reconfiguration step CONFIG. Before each configuration analysis step ANALYS, the content of the counter is compared with the pre-set number P. In case of equality, the transmitter/receiver is automatically placed in relation with the second communication network during a step SW2. In other words, the transmitter/receiver identified can refuse or delay a switch to the second communication work P times, but must obey request (P+1) or a communication in progress will be interrupted for lack of compatibility of the configuration of said transmitter/receiver with the characteristics specific to the second communication network.

In a particular mode of implementation of the invention, by selecting P=0 we can require the transmitter/receiver identified as being capable of communicating with the second communication network to switch immediately to said second network without any concern for its prior configuration. However, this choice risks interrupting the communication in progress if said prior configuration is not perfectly suited to the characteristics specific to the second communication network.

FIG. 4 is a schematic representation of a possible mode of embodiment of a radiotelephone RT capable of fulfilling the functions of a mobile transmitter/receiver in a data transmission method or a data processing system described above. This radiotelephone RT includes a principal controller CNT, typically constructed on the base of a microprocessor intended to handle the general management of the various functionalities of the radiotelephone RT, as well as to manage a man/machine interface thanks to which a user can communicate with the radiotelephone RT, an interface that comprises in this example a keyboard KB, a screen SCR, a microphone MC and a speaker HP. The principal controller CNT must also manage high-level communication protocol layers that are stored in a memory ROM specific to it.

The radiotelephone RT also includes a DSP signal processor intended to process signals transmitted or received by the radiotelephone RT in basic band. The radiotelephone RT also includes a radio part RF, adaptable by software means to different communication networks NW1, NW2 and to different associated frequency bands through loading in a memory RAMRF of the radio part RF of corresponding software modules Prog1, Prog2 that come from a memory MZ and contain information related to the characteristics specific to the other networks NW1, NW2. The radiotelephone RT described here can receive two antennas ANT1 and ANT2 each adapted to one of the networks NW1 or NW2, antennas whose use by the user of the radiotelephone can be detected by presence sensors C1 and C2 of the antennas ANT1 and ANT2.

The operation of the radiotelephone RT can be described as follows:

We presume that, during a first phase, the radiotelephone RT is in communication with a first communication network NW1, a first antenna ANT1 then being active. A first software module Prog1 is loaded into the memory RAMRF of the radio part RF, and into the memory RAMDSP of the DSP signal processor. When the radiotelephone RT enters an area in which a second communication network NW2 is operational in addition to the first network NW1, a message sent by a management infrastructure of said networks via the first communication NW1 network alerts the radiotelephone RT of this state of affairs. This message will describe characteristics specific to the second network NW2 and may contain a software module Prog2 to mitigate the possible absence of said module in the memory area MZ of the radiotelephone RT. The software module Prog2 thus received will be stored on the order of the principal controller CNT in said memory area MZ.

After receiving this message, the radiotelephone RT evaluates whether its configuration is compatible with the characteristics specific to the second communication network NW2. In particular, the principal controller CNT sounds the memory area MZ to verify the presence there of the software module Prog2 necessary to adapt the radio part RF to the second communication network NW2, and sounds its own memory ROM to look for the high-level protocol layers that correspond to said second network NW2 and observes the status of a presence sensor C2 of a second antenna ANT2 necessary in this example for informational exchanges with the second communication network NW2.

The radiotelephone RT then proceeds with making itself compatible with the characteristics specific to the second communication network NW2, a step during which the principal controller CNT selects for itself the adequate high-level protocol layers and orders the loading of the software module Prog2 into the memories RAMRF and RAMDSP of the radio part RF and of DSP signal respectively. If the second antenna ANT2 is declared absent by the presence sensor C2, the adaptation step may include a request to the user via the man/machine interface to ask said user to connect the second antenna ANT2. The adaptation step may also include the generation, by the principal controller CNT, of a request to a server, not shown in the figure and included in the first communication network NW1, to download the second software module Prog2 if this module is absent from the memory area MZ and was not included in the message alerting the radiotelephone RT of the existence of a second communication network NW2 operational in the location where the radiotelephone RT was located.

At the end of this adaptation step, the radiotelephone RT can be connected to the second communication network NW2 under optimal conditions.

1) data transmission method intended to place a communication network selected from a multiplicity of such networks into communication with at least one mobile transmitter/receiver, said communication networks each having specific characteristics that differ from one network to another,
method characterized in that it includes:
a location and selection step for a transmitter/receiver rendered capable by its geographic situation of communicating with at least two different communication networks, and
a transmission step to a transmitter/receiver selected at the end of the location and identification step of characteristics specific to communication networks operational in the location where said transmitter/receiver was located.

2) Data transmission method as claimed in claim 1, characterized in that it also includes a configuration analysis step for the transmitter/receiver selected at the end of the location and selection step and a step for evaluating a possible compatibility of said configuration with the characteristics specific to communication networks operational in the location where said transmitter/receiver was located.

3) Data transmission process as claimed in one of claims 1 or 2, characterized in that it also includes a configuration adaptation step for the transmitter/receiver selected at the end of the location and selection step, which adaptation step is intended to adapt said transmitter/receiver to at least one communication network operational in the location where said transmitter/receiver was located and distinct from a network with which the transmitter/receiver is already compatible.

4) Data transmission process as claimed in one of claims 1 through 3, characterized in that the location and selection step is performed by triangulation.

5) Telecommunication system including at least one mobile transmitter/receiver intended to be placed in communication with a communication network selected from a multiplicity of such networks, said communication networks each having specific characteristics that differ from one network to another, system characterized in that it includes:
means of location and selection of a transmitter/receiver rendered capable by its geographic situation of communicating with at least two different communication networks, and
transmission means intended to send to a transmitter/receiver selected by the means of location and selection characteristics specific to communication networks operational in the location where said transmitter/receiver was located.

6) Telecommunication system as claimed in claim 5, characterized in that it also includes configuration analysis means for the transmitter/receiver selected at the end of the location and selection step and a step for evaluating a possible compatibility of said configuration with the characteristics specific to communication networks operational in the location where said transmitter/receiver was located.

7) Telecommunication system as claimed in one of claims 5 or 6, characterized in that it also includes means of configuration adaptation for the transmitter/receiver selected at the end of the location and selection step, which adaptation means are intended to make said transmitter/receiver compatible with at least one communication network operational in the location where the transmitter was located and distinct from a network with which the transmitter/receiver is already compatible.

8) Telecommunication system as claimed in one of claims 5 through 7, characterized in that the means of location and selection include three base stations belonging to said networks for triangulating a position of said transmitter/receiver.

9) Telecommunication system as claimed in one of claims 5 through 7, characterized in that the means of location and selection include three satellites for triangulating a position of said transmitter/receiver.

10) Radiotelephone capable of performing the functions of a mobile transmitter/receiver used in a data transmission method as claimed in one of claims 1 through 4.

11) Radiotelephone capable of performing the functions of a mobile transmitter/receiver used in a telecommunication system as claimed in one of claims 5 through 9.
